(19) United States
(12) Patent Application Publication
(10) Pub. No.: US 2003/0074311 A1
(43) Pub. Date: Apr. 17, 2003

(54) Self-administered automatic payroll deduction

(75) Inventors: Eric Saylors, Lake Oswego, OR (US); Nicholas Anthony Lindsay Brown, Midlothian (GB); Maurice John Boardman, Gresham, OR (US)

Correspondence Address: LAW OFFICE OF KAREN DANA OSTER, LLC, PMB 1020, 15450 SW BOONES FERRY ROAD #9, LAKE OSWEGO, OR, 97035, US

(73) Assignee: NewAttitude Inc., Lake Oswego, OR

(21) Appl. No.: 10/273,961

(22) Filed: Oct. 16, 2002

Related U.S. Application Data
(60) Provisional application No. 60/329,773, filed on Oct. 16, 2001.
(60) Provisional application No. 60/338,770, filed on Dec. 5, 2001.
(60) Provisional application No. 60/342,607, filed on Dec. 21, 2001.

(51) Int. Cl. G06F 17/60

(52) U.S. Cl. 705/39

(57) ABSTRACT

The present invention is directed to a method for allowing an employee (100) to self-administer automatic payroll deductions from his gross pay (120) through a money management system (130). Preferably, the employee (130) self-registers in the money management system via the web. Then the employee (100) may submit at least one transaction request to facilitate a financial obligation to at least one vendor (104). The system (130) then arranges for payment of the financial obligation and directs the payroll system (116) to withdraw funds from the employee's gross pay (120) (using at least one automatic payroll deduction) and to transfer the withdrawn funds to the at least one vendor (104). In one preferred embodiment, the system (130) provides access to a lender-vendor (104a) to arrange financing for the financial obligation and to a credit-risk reducing feature (104b) such as insurance.

The present application is a nonprovisional of U.S. Provisional Patent Application Serial No. 60/329,773, filed Oct. 16, 2001, a nonprovisional of U.S. Provisional Patent Application Serial No. 60/338,770, filed Dec. 5, 2001, and a nonprovisional of U.S. Provisional Patent Application Serial No. 60/342,607, filed Dec. 21, 2001. The present application is based on and claims priority from these provisional applications, the disclosures of which are hereby incorporated herein by reference.

### BACKGROUND OF INVENTION

The present invention is directed to a self-administered automatic payroll deduction system, and more specifically to a web-dependent self-administered automatic payroll deduction system that may include a web service automatic payroll deduction setup feature and/or a web service eligibility check feature.

FIG. 1 shows the existing payroll network system in which each individual (for the purpose of this disclosure, an employee 100) has a monthly responsibility and commitment to micromanage his own money. Every month (or on an alternate periodic or non-periodic basis), after receiving his net pay 102 in the form of a check, direct deposit, or other form of payment (e.g. replenishment of a payroll debit card), the employee 100 must make payment 106 to a multiplicity of vendors 104 that offer goods and/or services. The monthly process of bill payment can take hours, as the employee 100 must locate all the bills that need to be paid, write the checks, balance the accounts, find envelopes (and write the address thereon) and stamps (at an additional cost), and verify that the previous month's payments have been received by the respective vendors. A missing bill or a lost payment can result in the addition of hours of hours of extra work and probable surcharges to this cumbersome and risky bill payment process. Online bill payment systems (such as CheckFree®) allow the employee 100 to make certain types of payments online. Certain bill payment systems charge a monthly fee for this service.

If the employee 100 does not have enough money to pay the vendors 104, the employee 100 must finance his debt using credit cards or other forms of loans (e.g. home loans, equity loans). The employee 100 generally must pay a fee for the loan either in the form of interest or extra “junk fees.” Some employers 110 will allow employees 100 to have a cash advance on future paychecks by following a generally humiliating process of asking the boss or human resource department for a loan based on an “emergency” or “exigent circumstances,” and the often time consuming and/or difficult process of filling out forms or other paperwork. This “perk” is really just allowing the employee 100 access to his money.

Employees also struggle with basic money management. Ideally, in addition to paying monthly bills, every employee would put aside money for retirement or other savings. However, nearly half of all Americans have less than $10,000 saved for retirement. In addition, more than 50 million households carry credit card debt with an average balance of $7,000. Obviously, the money management tools currently available are insufficient for the average wage earner to manage their money effectively.

Automatic payroll deductions (APDs) have become a universal means for withholding taxes and a widely used means for paying for everything from insurance, union dues, charitable contributions, 401(k), and other savings/investment plans. In fact, payroll deduction is the most reliable, convenient, and “painless” way for a consumer to pay a bill. The authors of the Tax Act of 1942 instituted tax withholding because it is easier to collect taxes from employers than it is to collect from individual taxpayers. This method of collecting taxes is extremely reliable, with compliance among employers approaching 100 percent. Automatic payroll deductions have also made saving easier. Employees with access to automatic payroll deductions for 401 (k) contributions are more likely to continue on a regular savings plan than counterparts whose employers do not offer such a program.

Some employers have begun to recognize that automatic payroll deductions can be used to allow an employee to pay for computers and some finance companies have started to offer programs by which employers can offer their employees credit card-like products that are paid using payroll deductions. These programs, however, are complicated (e.g. they require the employer to develop specific policies and procedures) and risky to the employer (e.g. if the employee quits, dies, is fired, or otherwise leaves the employer's company, the employer runs a high risk of never being paid back). The problems are enough to prevent most employers from implementing such programs.

The credit card-like products that have been introduced in the last few years are generally administered by third parties and can be offered by employers as a benefit to their employees. The card in these credit card-like products may be used in a manner similar to a credit card for purchases, but payments are deducted from the employee's paycheck using automatic payroll deduction. These credit card-like products are extremely limited in scope and have strict limitations such as who can participate (e.g. age requirements), minimum salary requirements, the percentages of the paycheck that may be spent, and the products that can be purchased. In addition, in effect these credit card-like products encourage spending and debt, not efficient money management.

Payroll processors such as ADP®, Paychex®, ProBusiness®, Ceridian®, and PrimePay®, makes up a payroll network that annually handles approximately $3.6 trillion in wages for employed workers. Employers using payroll software produced by such companies as Micorsoft (Great Plains Accounting), Peoplesoft, SAP, Oracle, or Intuit also handle a significant amount of money. Payroll processors and payroll software systems are already handling automatic payroll deductions. Throughout this disclosure, the term “payroll system” will be used to describe payroll processors, payroll software, or other entities that perform some or all of the functions of payroll processors and/or payroll software.

FIG. 1 shows one exemplary procedure in which automatic payroll deduction is currently being set up, altered, and/or applied. Specifically, FIG. 1 shows the employee 100 submitting an automatic payroll deduction enrollment or alteration form 112 to the employer 110 (or the employer's human resource department), the employer 110 doing data entry 114 into a payroll processor 116a (but the employer's own payroll software system could be used), and a report (or confirmation or paperwork) 118 being returned to the employer 110. Thereafter, for each of the employee's 100 paychecks, allotted percentages or fixed amounts are deducted from the employee's gross pay 120 and distributed for taxes 122 and benefits or other automatic payroll deductions 124.

No one has yet realized the potential of using the existing electronic communication media for automatic payroll deductions and broad-based consumer acceptance of this payment method to create a more efficient consumer finance model.

The present invention is directed to features that may be incorporated into U.S. patent application Ser. No. 09/894,644 to Saylors and entitled “Web Dependent Consumer Financing and Virtual Reselling Method” (the “Consumer Financing” reference). The Consumer Financing reference was invented by one of the inventors of the present invention, has been assigned to the assignee of the present application, and is hereby incorporated herein by reference. The Consumer Financing reference discloses an invention that offers a new type of consumer financing that results in universal access to consumer credit for reliable workers (an employed customer). The Consumer Financing reference invention includes one or more features such as a new model for consumer financing of any product, the use of electronic communication media, the use of virtual resellers to receive an order for the product (and, possibly, manufacturers and/or distributors), means for repayment monitoring, and credit enhancement provided by credit-risk reducing features such as insurance or a recourse reserve fund. In one preferred embodiment of the invention disclosed in the Consumer Financing reference, the lender's decision to fund the employed customer may be based, at least in part, on the employed customer's employment (and the employer's agreement to use automatic payroll deductions) and/or the presence of the credit-risk reducer. The method of the Consumer Financing reference invention results in efficiencies that make credit enhancement viable for every customer.

### BRIEF SUMMARY OF THE INVENTION

The present invention uses existing payroll networks and electronic communication media for automatic payroll deductions to create a more efficient consumer finance model. More specifically, the present invention is directed to a web-dependent self-administered automatic payroll deduction system that may include a web service automatic payroll deduction setup feature and/or a web service eligibility check feature.

The present invention is directed to a method for allowing an employee to self-administer automatic payroll deductions from his gross pay through a money management system. Preferably, the employee (who is employed by an employer having a payroll system with automatic payroll deduction capabilities) self-registers in the money management system. Preferably, the employee self-submits his registration request via the web. Then, the employee may submit at least one transaction request to facilitate a financial obligation to at least one vendor. The system then arranges for payment of the financial obligation through the payroll system. The system then directs the payroll system to withdraw funds from the employee's gross pay using at least one automatic payroll deduction and directs the payroll system to transfer the withdrawn funds to the at least one vendor.

In one preferred embodiment, the system provides access to a lender-vendor to arrange financing for the financial obligation and to a credit-risk reducing feature such as insurance. The lender-vendor may determine creditworthiness of the employee based at least in part on the reliability factor provided by automatic payroll deductions. The lender-vendor may also determine creditworthiness of the employee based at least in part on the reliability factor provided by the credit-risk reducing feature.

The system may also monitor and verify that the payroll system has withdrawn funds and transferred the withdrawn funds as directed.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a schematic diagram of a prior art system in which automatic payroll deductions may be set up, altered, and/or applied.

FIG. 2 is a schematic diagram of an exemplary embodiment of the self-administered automatic payroll deduction system of the present invention in which automatic payroll deductions may be set up, altered, and/or applied.

FIG. 3 is a schematic diagram of an exemplary relationship between parties of the present invention and a basic schematic of an exemplary system of the present invention and subsystems thereof as well as the paths through which the internal processes may flow.

FIG. 4 is a schematic diagram of a first preferred exemplary embodiment of an employer setup process of the present invention in which an outsourced payroll processor is used.

FIG. 5 is a schematic diagram of a second preferred exemplary embodiment of an employer setup process of the present invention in which the employer uses payroll software.

FIG. 6 is a schematic diagram of an exemplary embodiment of a vendor registration process of the present invention.

FIG. 7 is a schematic diagram of a first preferred exemplary embodiment of an employee registration process of the present invention in which the employee controls all information about the employee.

FIG. 8 is a schematic diagram of a second preferred exemplary embodiment of an employee registration process of the present invention in which the payroll system controls at least some information about the employee.

FIG. 9 is a schematic diagram of a first preferred exemplary embodiment of an employee update process of the present invention in which the employee controls all information about the employee.

FIG. 10 is a schematic diagram of a second preferred exemplary embodiment of an employee update process of the present invention in which the employee controls all the information about the employee and the payroll system requires notification of updates.

FIG. 11 is a schematic diagram of a third preferred exemplary embodiment of an employee update process of the present invention in which the payroll system controls at least some information about the employee.

FIG. 12 is a schematic diagram of an exemplary embodiment of a change in employee employment status process of the present invention in which the payroll system provides information about the employee's change in employment status.

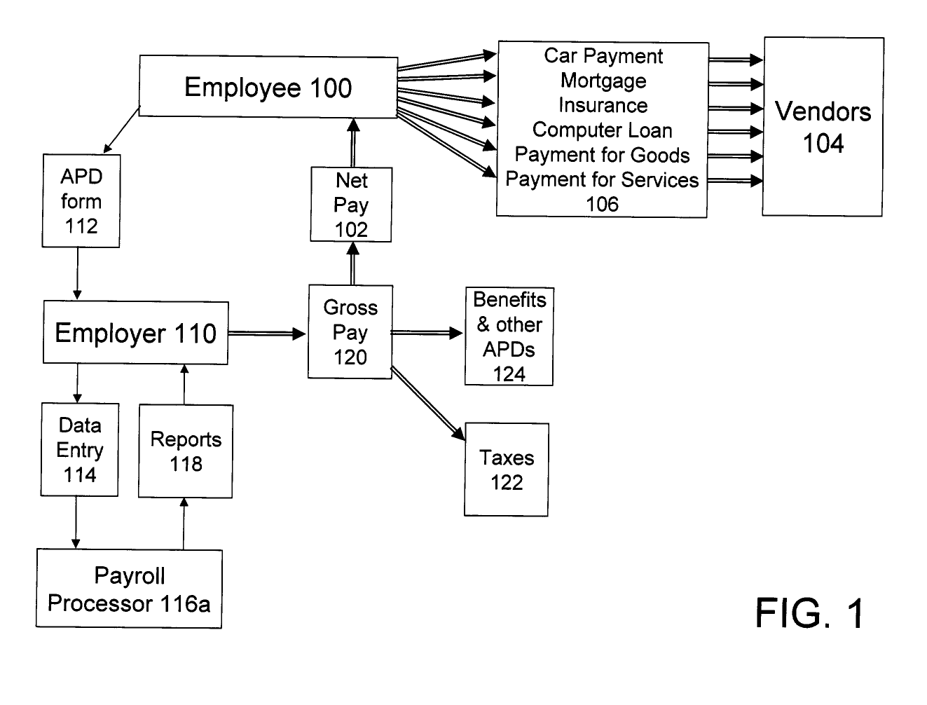

FIGS. 1 3A and 1 3B are schematic diagrams of an exemplary embodiment of an employee purchase process of the present invention in which the purchase is made through a registered vendor.

FIG. 14 is a schematic diagram of an exemplary embodiment of an employee purchase process of the present invention in which the purchase is for an ongoing service and is made through a registered vendor.

FIG. 15 is a schematic diagram of an exemplary embodiment of an exemplary employee payment process in which the payment is made to a non-associated vendor.

FIG. 16 is a schematic diagram of a first preferred exemplary embodiment of a payroll process of the present invention in which the system of the present invention monitors all transactions.

FIG. 17 is a schematic diagram of a second preferred exemplary embodiment of a payroll process of the present invention in which the system of the present invention does not monitor all transactions.

FIG. 18 is a schematic diagram of the virtual flow of money using an exemplary embodiment of the present invention.

### DETAILED DESCRIPTION OF THE INVENTION

The present invention uses existing payroll networks and electronic communication media for automatic payroll deductions to create a more efficient consumer finance model. More specifically, the present invention is directed to a web-dependent self-administered automatic payroll deduction system that may include a web service automatic payroll deduction setup feature and/or a web service eligibility check feature.

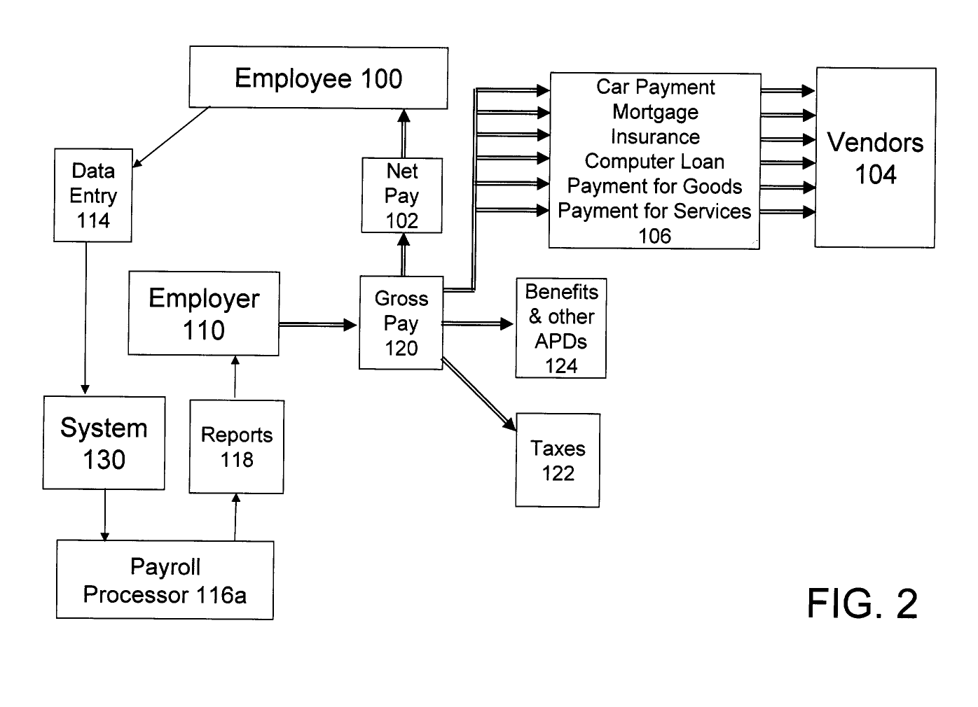

As an introduction to the system of the present invention, FIG. 2 shows an exemplary embodiment of the self-administered automatic payroll deduction system of the present invention in which automatic payroll deductions may be set up, altered, and/or applied. Specifically, FIG. 2 shows an employee 100 directly entering setup, alteration, or transaction data 114 into the system 130 of the present invention. The system 130 provides accounting and/or employee information to the payroll processor 116a (which could be replaced by the employer's own payroll software 116b system), and reports 118 are returned to the employer 110. Thereafter, for each of the employee's 100 paychecks, allotted percentages or fixed amounts are deducted from the employee's gross pay 120 and distributed for taxes 122, benefits or other automatic payroll deductions 124, and to a multiplicity of vendors 104 that offer goods and/or services. The remaining amount is distributed to the employee 100 as net pay 102. In effect, the result is digital money management—a foundation for realizing the vision of the “digital wallet.”

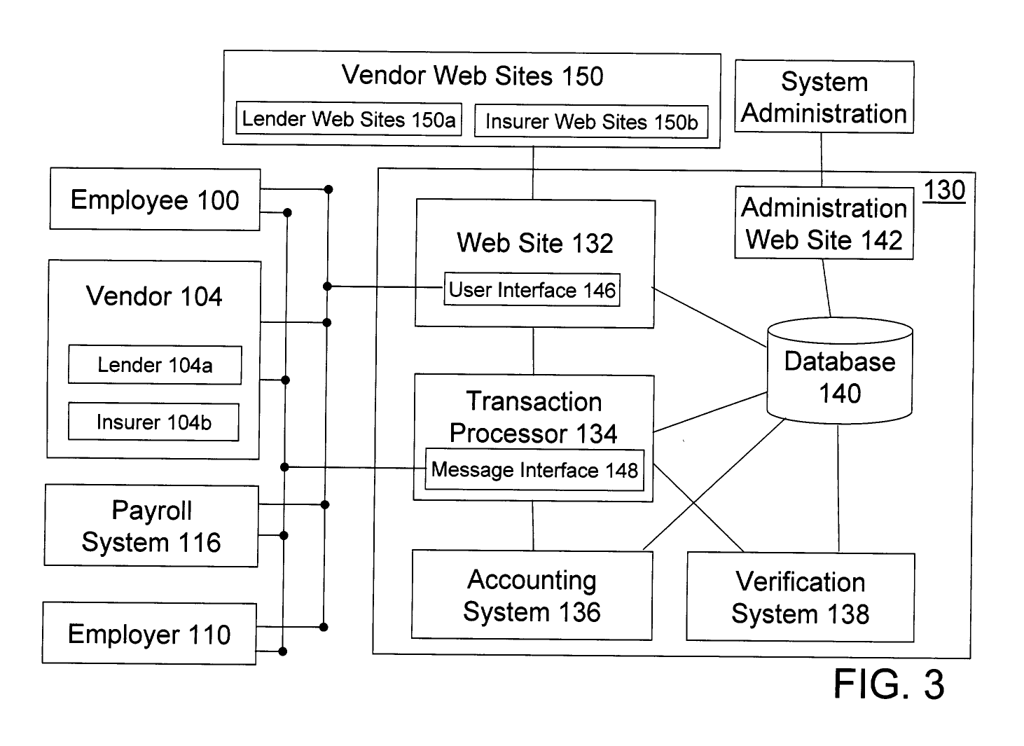

Before turning to the specifics of how the present invention functions, each of the components of an exemplary system (such as that shown in FIG. 3) will be discussed. It should be noted that even if only a single component is shown, for certain types of components, it is probable that more than one component will be used. For example, the number of employees 100 and vendors 104 could be almost limitless and the system would be adjusted to compensate for the appropriate load.

For purposes of this disclosure, the term “employee 100” has been used. The term employee is used to describe an individual that is an employee, a customer, a client, a service user, a lendee, a taxpayer, a saver, and/or any other user of the system. The definition of employee is extended herein beyond its ordinary meaning in that in may include anyone who receives income through a payroll processor or payroll software system. For example, a self-employed person could pay himself through a commercial payroll processor such as ADP and thereby take advantage of the present invention. Similarly, if payments are from social security, retirement programs, brokerage accounts, welfare, or any other source of income that is (or could be) distributed using a payroll processor or payroll software system, the individual receiving payments could be considered an “employee 100” for the purpose of this invention. It is also possible that the employee 100 of the present invention could be set up as an individual who receives income from an alternative source (e.g. a bank), even if the income does not flow through a payroll processor or payroll software system. Every employee 100 has a unique employee identification that may be his social security number, a Microsoft® .NET Passport, or a unique identification generated by the system 130. The unique employee identification, once entered into the system, is connected to information about the employee 100 such as his name, address, phone number, social security number, bank routing numbers, current employer, current salary or other determination of payroll limits, current payroll deduction status, and other relevant data. Appropriate safeguards such as password protection and limited access grants would be included in most implementations of the present invention.

One of the unique features of preferred embodiments of the present invention is that the employee 100 does all (or at least a majority) of the data entry 114. This has several advantages. For example, it eliminates (or greatly reduces) paper-based transactions. As the employee 100 is inputting the data, there is less of a chance that he will spell his name incorrectly or otherwise provide incorrect data. (In systems where someone other than the employee does data entry, errors could be introduced by the employer or by the other party who is unfamiliar with the data.) It also reduces costly administrative processes in which the employer, payroll processor, lender, system, or other entity must supply personnel to do the data entry. This also reduces the “humiliation factor” in which the employee must, in effect, beg for his own money. An easy to use user interface will make using the system quick and efficient for the employee 100 who, because he wants access to his own money, will have incentive to use it. Because the employee directly enters the data, delays caused by busy third-party personnel are eliminated.

There are many incentives for an employee 100 to use the system of the present invention. In addition to allowing an employee 100 to access his own money, this invention provides a powerful budgeting tool. Used properly, the employee can make all necessary payments from his gross pay so that the net pay he receives is actually money that has not been previously allocated. In other words, the employee is able to allocate funds for goods and/or services such as paying his taxes, paying for loans, making investments, and paying for goods and services on a one-time basis or on a periodic basis. These payments are made conveniently in that there is no need to write a check and mail payment to a vendor. Although a fee may be associated with the use of the system, the savings in postage, material costs, and late fees would substantially compensate the employee for the use of the system. There are also significant timesavings in not having to buy, find, or prepare regular postal mail payments.

As evident from the above description of the term “employee 100,” the term “employer 110” is similarly extended herein beyond its ordinary meaning in that in may include any entity that provides payment through a payroll processor or payroll software system. For example, a self-employed person who pays himself through a commercial payroll processor such as ADP would be an employer for purposes of this invention. Similarly, entities that provide payments (e.g. social security, retirement programs, brokerage accounts, welfare, insurance companies, or any other source of income that is (or could be) distributed using a payroll processor or payroll software) could be considered an “employer 110” for the purpose of this invention. Every employer 110 has a unique employer identification that may be its employer identification number or a unique number. The unique employee identification, once entered into the system, is connected to information about the employer 110 such as its name, address, phone number, employer identification, bank routing numbers, current employees, payroll processor/software, and other relevant data. Appropriate safeguards such as password protection and limited access grants would be included in most implementations of the present invention.

There are many incentives for an employer 110 to use the system of the present invention. An employer 110 may offer this system to its employees 100 as a perk or benefit without cost to itself. This benefit, like other benefits, can have the effect of increasing employee retention. For certain types of purchases (e.g. computers), the employer 110 may find that its employees 100 are more likely to learn and become comfortable with new technology on their own time. Having the specific parties perform their own data entry substantially eliminates errors and significantly reduces workload of the employer's personnel. The employer's 110 responsibility for the accuracy of the information input by the employee 100 would also be reduced or eliminated. In addition, because installment and other payments are consolidated electronic fund transfers, there is no more work for the employer 110 in using the present invention than using the current system. An advantage of one alternative embodiment is that an employer 110 may receive additional volume discounts if employees 100 purchase products through the same vendors 104 that the employer 110 uses. Yet another advantage of the present invention is that the employer 110 may be able to transfer fees it normally pays the payroll processor 116a for automatic payroll deductions to the employee 100. The employer 110 would be indemnified by its employees 100 and would not incur any additional responsibilities or liabilities based on its employees' use of the system.

Although FIG. 2 shows a payroll processor 116a, the present invention may also be implemented using an employer's payroll software 116b. Throughout this disclosure, exemplary embodiments use the terms payroll processor 116a to describe an outsourced payroll system, payroll software 116b to describe an “insourced” payroll software system generally operated by the employer 110, and “payroll system 116” when either/or both the payroll processor 116a or payroll software 116b could be used. It should be noted, however, that the use of the terms payroll processor 116a and payroll software 116b may be exemplary and are not necessarily exclusionary. For example, FIG. 2 shows a payroll processor 116a as an example, but the payroll processor 116a could be replaced with payroll software 116b. Throughout this disclosure, the term “payroll system 116” will be used to describe payroll processors, payroll software, or other entities (e.g. banks, accounting firms) that perform some or all of the functions of payroll processors and/or payroll software.

There are many incentives for a payroll processor 116a to use the system of the present invention. In one preferred embodiment of the present invention, the payroll processor 116a would receive a fee per transaction or on a periodic basis. Having the specific parties perform their own data entry substantially eliminates errors and significantly reduces workload of payroll processor personnel. In addition, because installment and other payments are consolidated electronic fund transfers, there is no more work using the present invention than using the current system. Another advantage for the payroll processor 116a is based on the timing of payments. Specifically, the payroll processor 116a may receive a “float” on automatic payroll deductions after they have been withheld from the employee 100, but before the payment has been made to the vendors 104. It should be noted that early adopters of the present invention might be able to attract employers 110 as new clients. As the present invention becomes predominant, payroll processors 116a that do not offer this system may lose clients.

For the purpose of this disclosure, the term “goods and/or services” is used to describe exemplary “financial obligations” or “purchases” such as taxes, loans (e.g. car payments, mortgages, credit card purchases, charitable contributions, computer loans), investments (e.g. 401(k) plans, stocks, savings programs, IRAs, 529 plans), financial obligations (e.g. child support, alimony), services (e.g. housing, insurance, utilities, educational services, medical services, travel services, memberships, subscriptions), and goods (e.g. consumer purchases). These exemplary goods and/or services have been categorized for exemplary purposes only and, except as otherwise noted, may be categorized in many alternative ways. The term “financial obligations” may also be used to describe the price for the goods and/or services or payments directed towards goods and/or services.

As implied by the definition of the term “goods and/or services,” the term “vendor 104” is used to describe such exemplary goods and service providers as the government, lenders (e.g. car loan companies, mortgage companies, credit card companies, computer loan providers, banks), investment companies (e.g. those that offer 401(k) plans, stocks, savings programs, IRAs, 529 plans), charities, service providers (e.g. landlords, insurance companies, utility companies, schools, doctors and hospitals, travel providers (e.g. travel agencies, hotels, airlines, car rental companies)), and/or goods providers (e.g. stores, original equipment manufacturers, distributors, magazine, and other service providers). These exemplary vendors 104 have been categorized for exemplary purposes only and, except as otherwise noted, may be categorized in many alternative ways. Every vendor 104 has a unique vendor identification that may be its Microsoft®.NET Passport ID, tax identification number, or a unique identification generated by the system 130. The vendor identification, once entered into the system, is connected to information about the vendor 104 such as its name, address, phone number, Microsoft®.NET Passport ID, tax identification number, bank routing numbers (or other information required for electronic funds transfers), web site link, rules for its customers (e.g. if it requires signed documents), and other relevant data. Appropriate safeguards such as password protection and limited access grants would be included in most implementations of the present invention.

There are many incentives for a vendor 104 to use the system of the present invention. One advantage is that the system would virtually guarantee prompt payments. For providers of goods, another advantage is that it enables more people to have greater purchasing power because they have access to their future funds, they can better budget their money, and they are more likely to receive a loan using this system. Vendors 104 who use this system also may have the opportunity to market to more potential buyers. In one preferred embodiment of the present invention, certain types of vendors 104 (e.g. lenders and/or insurers) would receive a fee per transaction or on a periodic basis. Having the specific parties perform their own data entry substantially eliminates errors and significantly reduces workload of the vendor's personnel. In addition, because installment and other payments are consolidated electronic fund transfers, there is considerably less work using the present invention than using the current system because the present invention facilitates paperless transactions and eliminates repetitive, manual, processing and data entry.

FIG. 3 also shows a basic schematic of an exemplary system 130 of the present invention and paths through which the internal processes may flow. In this shown diagram, the system 130 is the central hub and the employee 100, vendor 104, employer 110, and payroll system 116 are networked or otherwise connected to the system 130. In this shown embodiment, all information flows either to or from the system 130. For two parties to communicate using this shown system 130, the information would have to flow through the system 130. In alternative embodiments, the information may flow directly between the other parties or may flow simultaneously to/from a party and to/from the system 130. In most of the other figures, the flow of the information shown and/or described is the virtual flow and the actual path may be through the system 130 or via another indirect path.

As shown, the system 130 includes several subsystems: a web site 132, a transaction processor 134, an accounting system 136, a verification system 138, a database 140, and an administration web site 142. These subsystems are meant to be exemplary and may be divided or combined with each other. Further, additional subsystems could be added and some subsystems could be eliminated (e.g. the administration web site 142). The pathways shown are also meant to be exemplary and alternate pathways may be used (e.g. the administration web site 142 may be connected to each of the subsystems).

The web site 132 is preferably a user-friendly web site with a user interface 146 that allows easy, but secure, access to all relevant parties. One exemplary web site 132 would include a home page with a brief explanation of the system 130 and links to separate portions of the web site 132 for employees 100, vendors 104, employer 110, and payroll system 116. To access the web site 132, the parties would be prompted to enter their respective unique identification and a password. Alternative embodiments may use alternative security measures. As appropriate, the web site 132 may include links to vendor web sites 150 such as a lender-vendor web site 150a, an insurer-vendor web site 150b, a goods-vendor web site 150c (FIGS. 13A and 13B), and/or a service-vendor web site 150d (FIG. 14). The vendor web sites 150 may be traditional web sites or they may be sites created by the system 130 for the vendors 104 upon registration. These links may be selectable by the user and/or they may be transparent to the user.

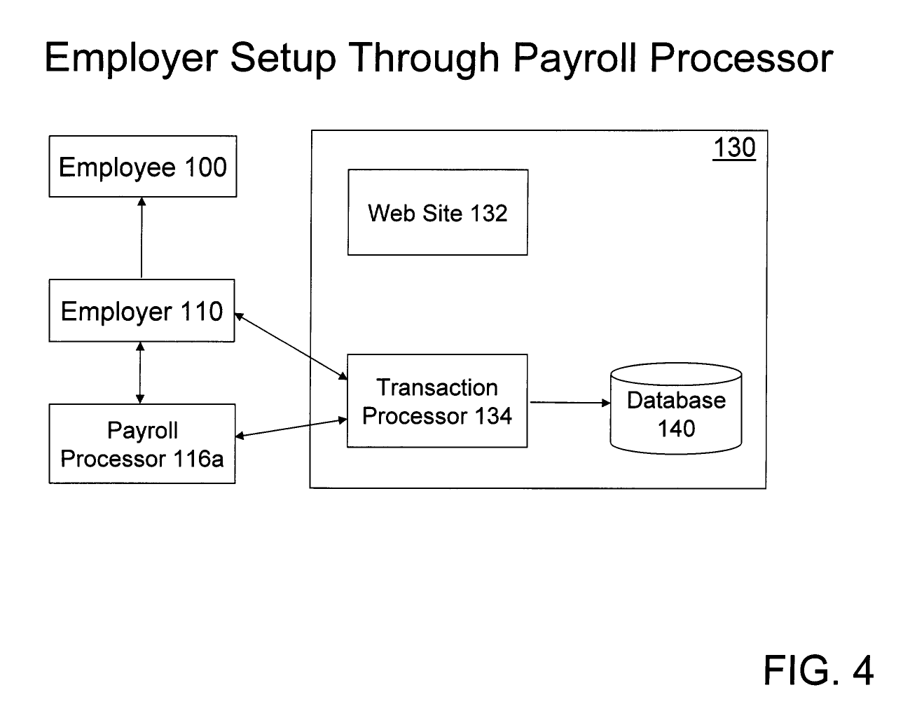

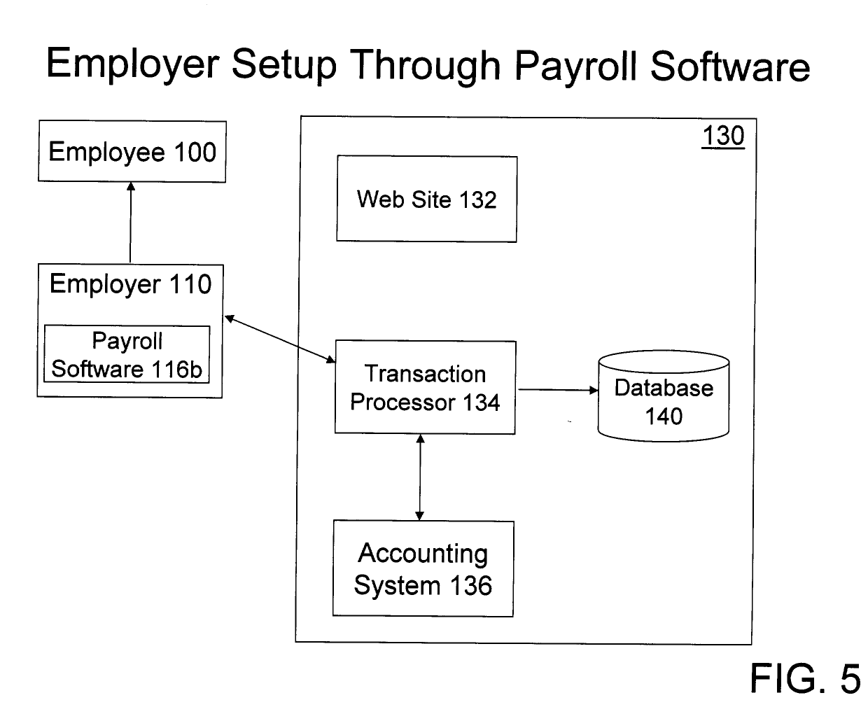

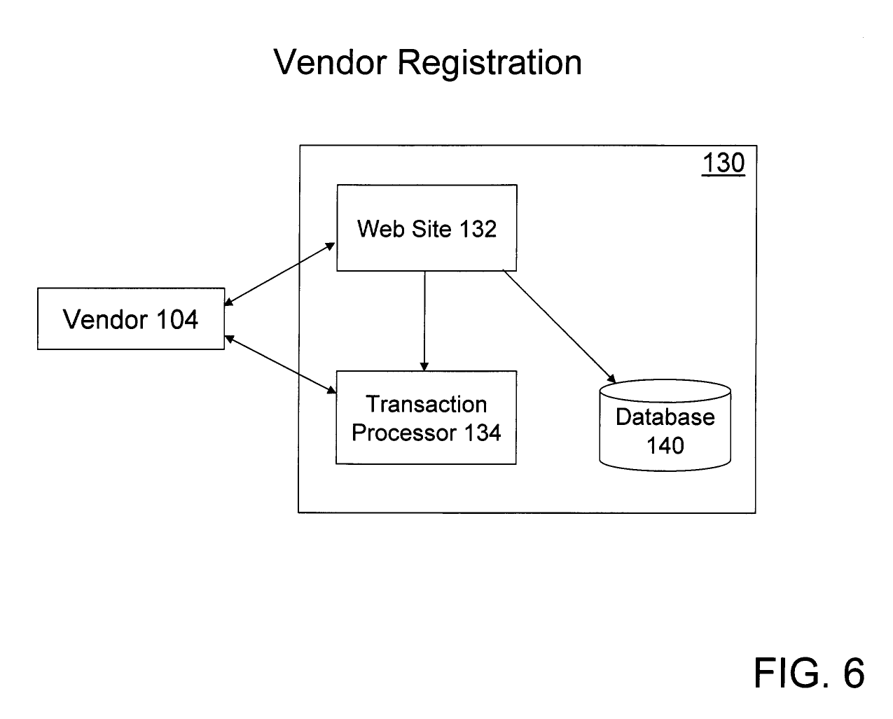

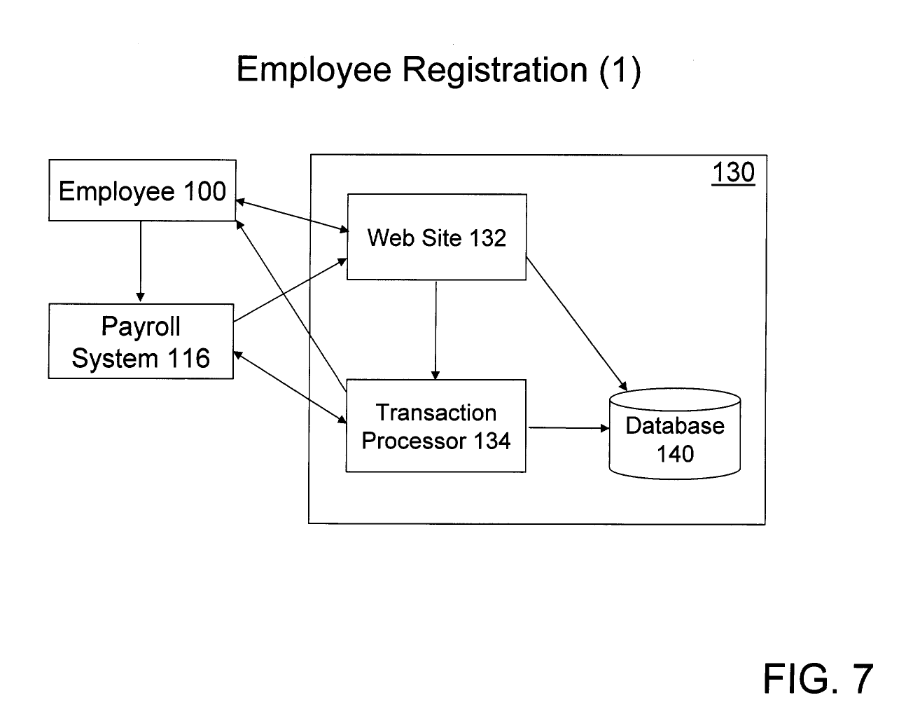

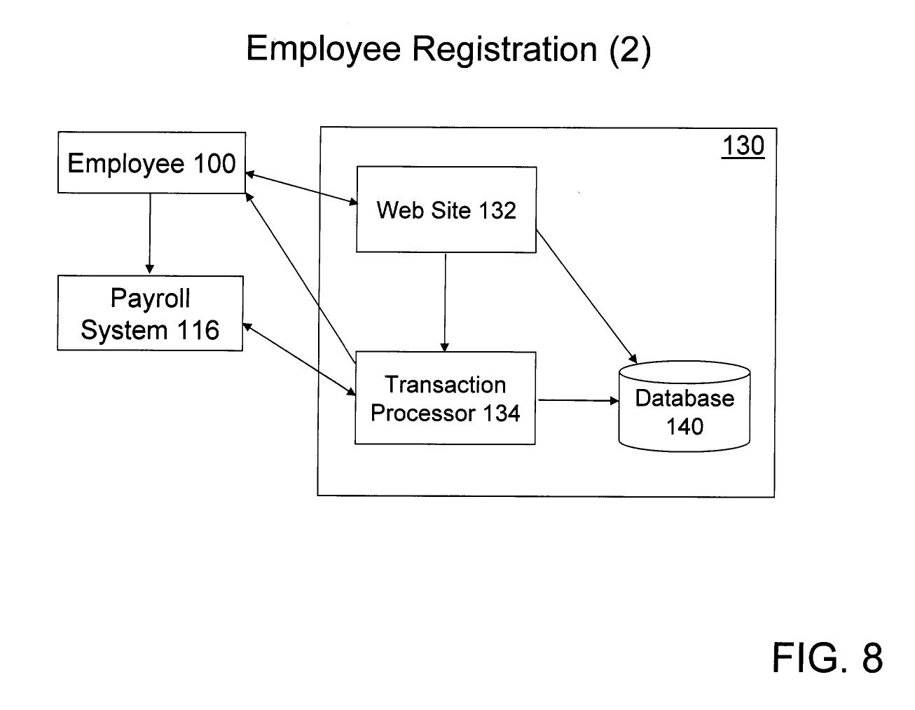

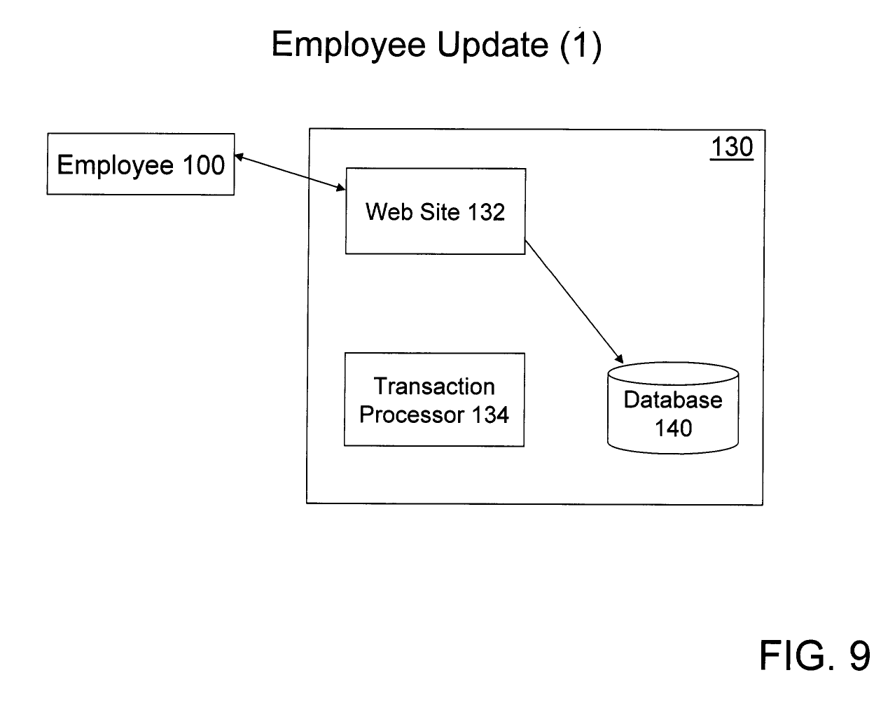

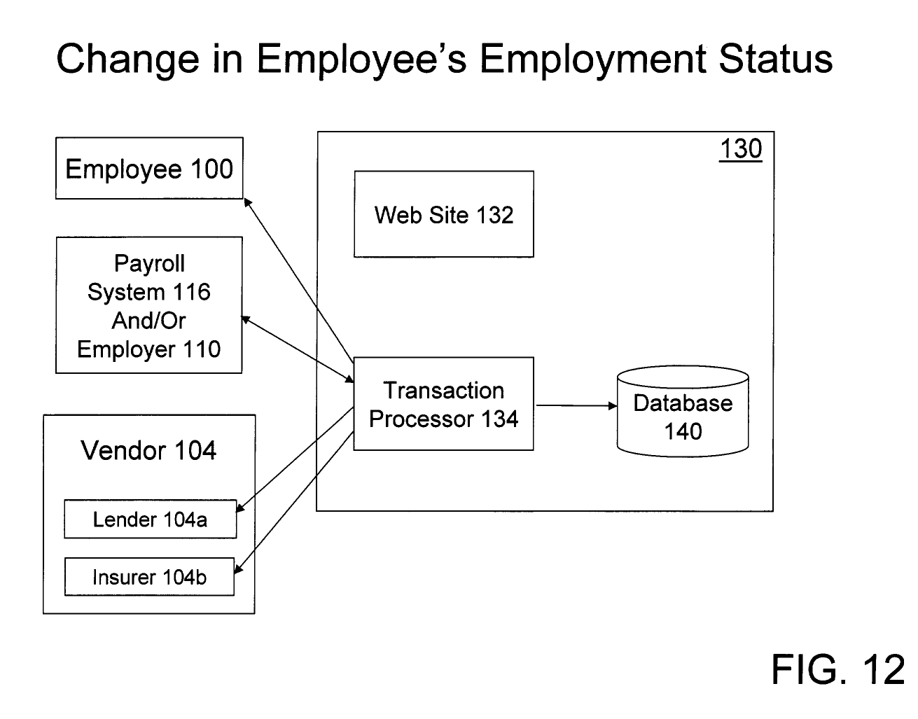

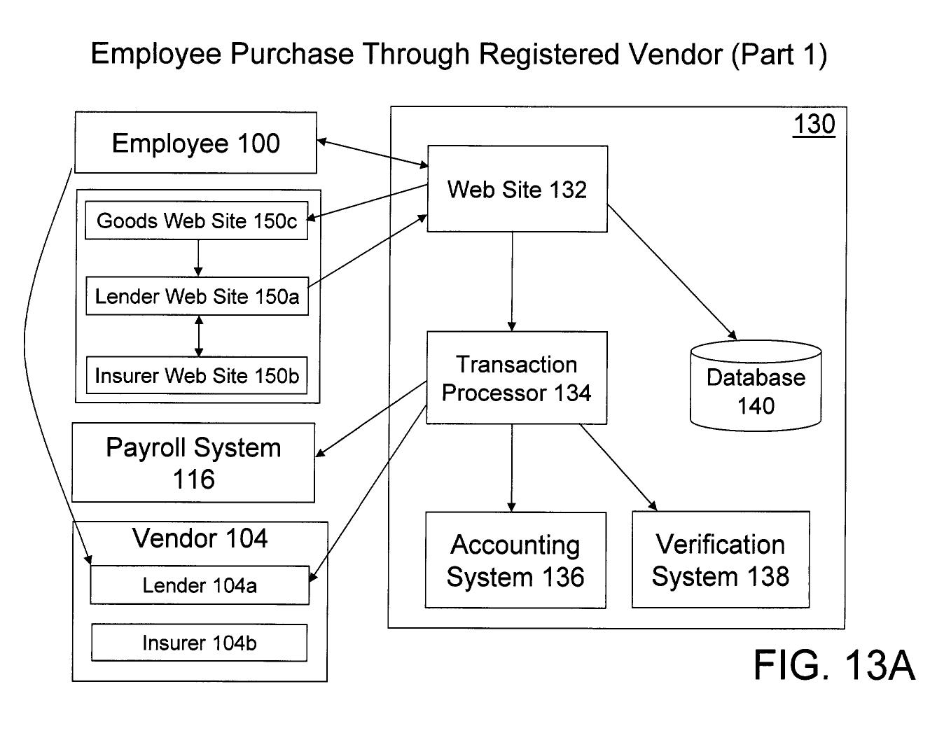

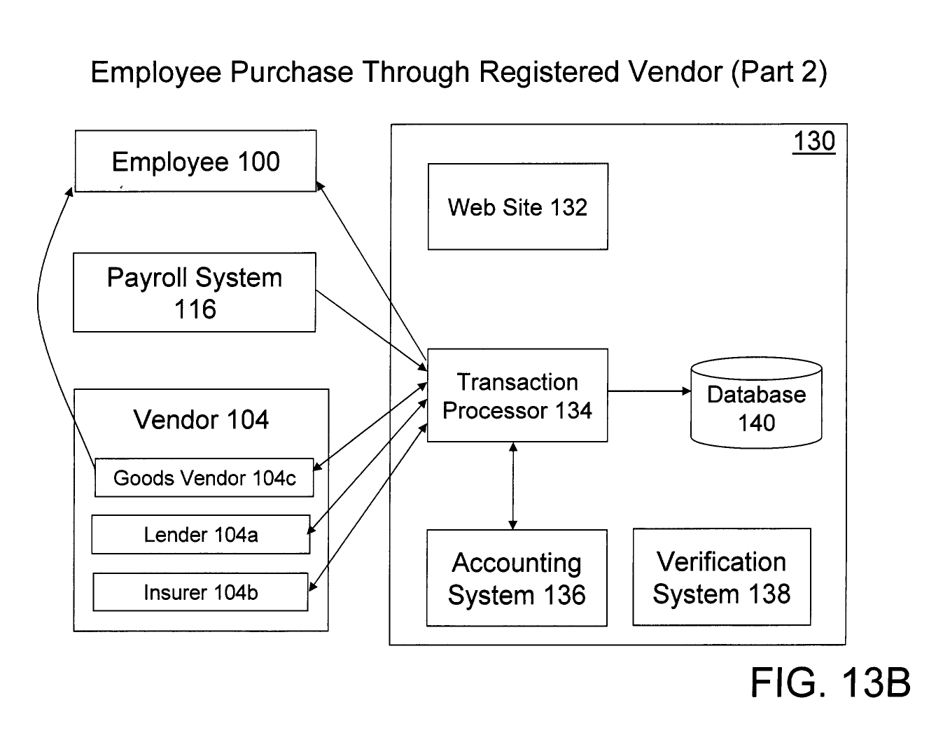

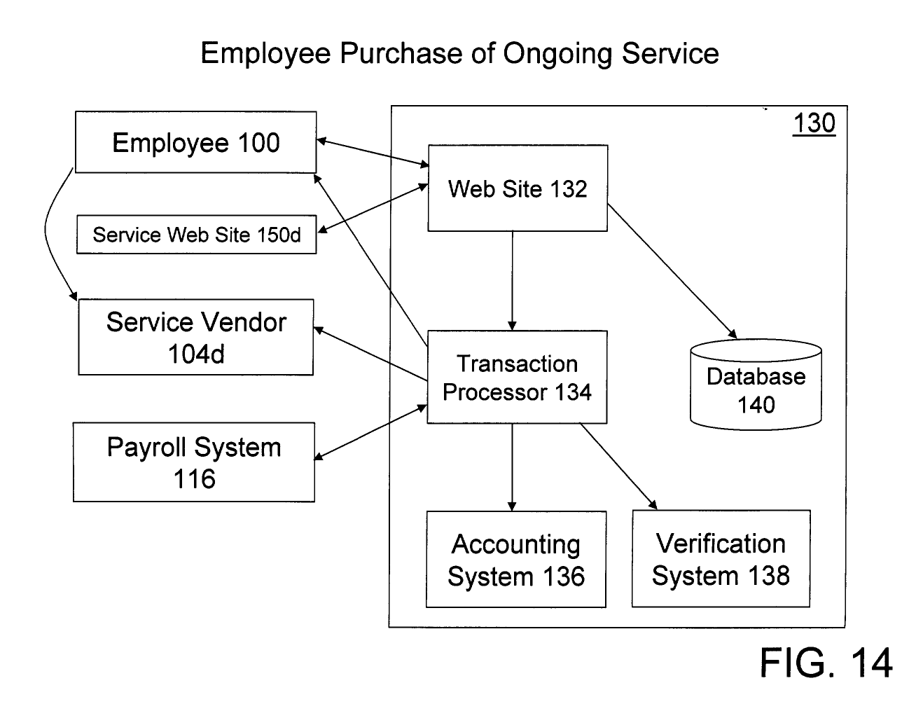

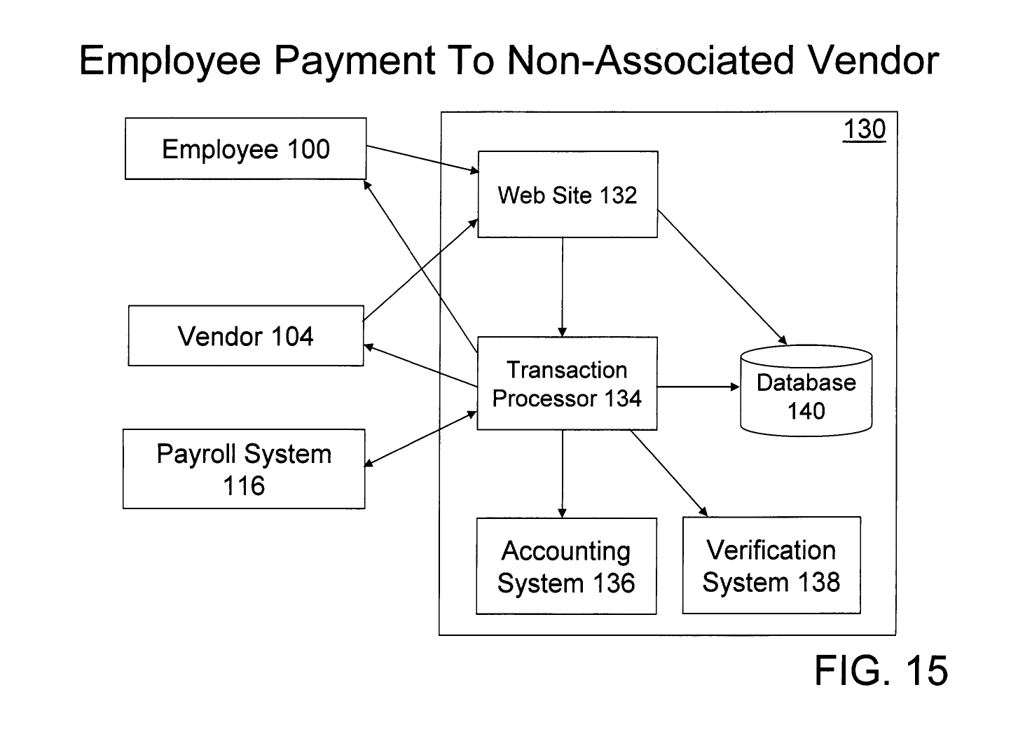

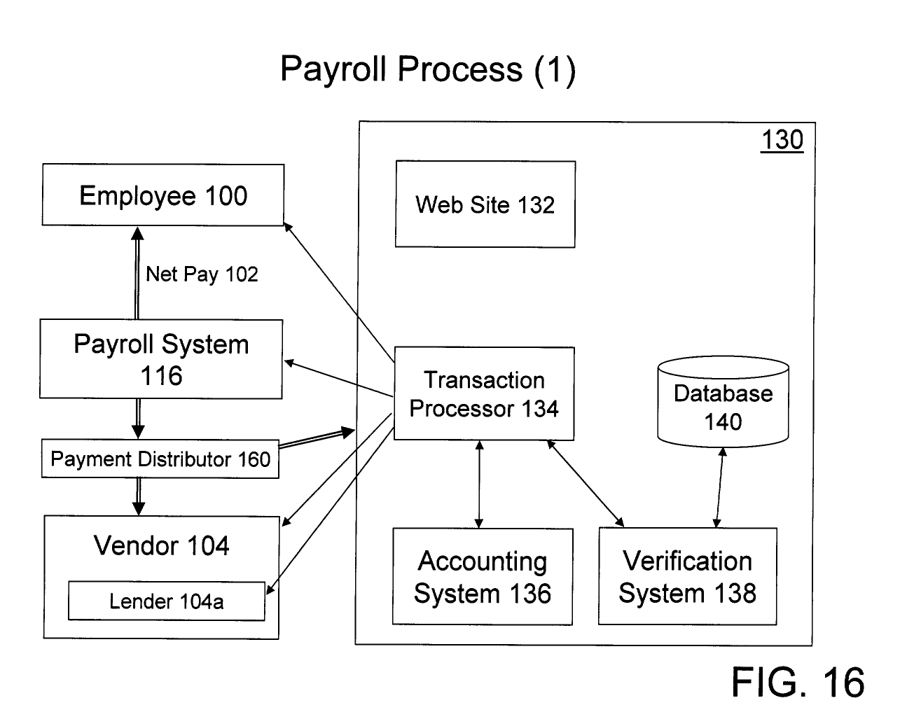

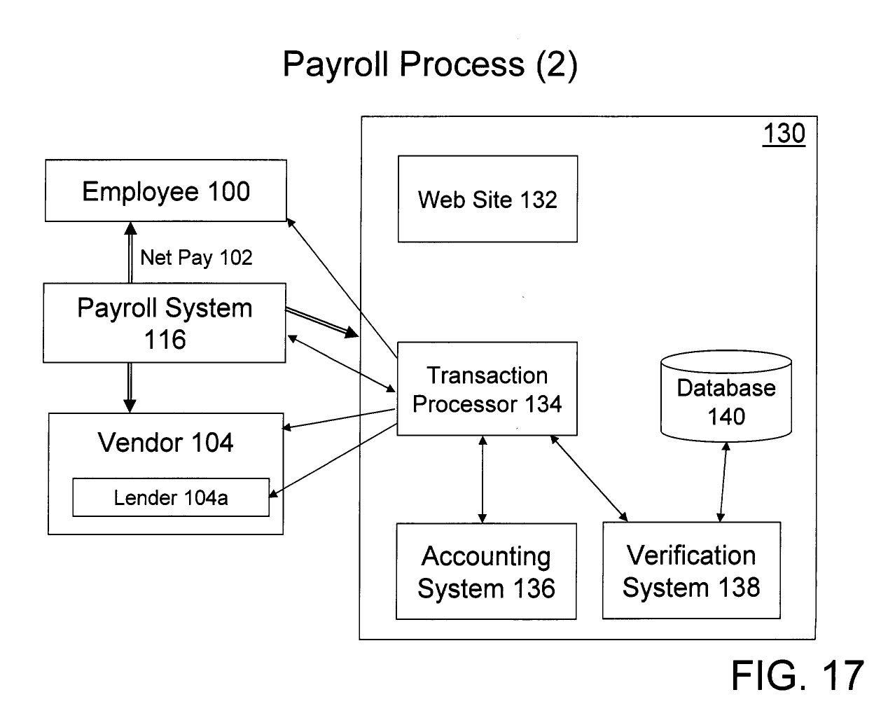

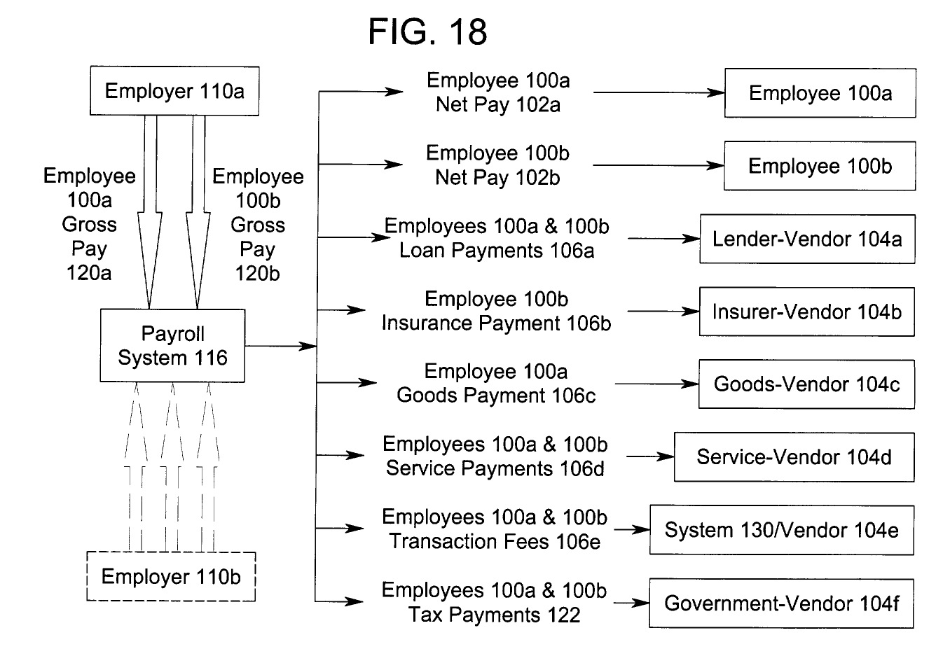

In one preferred embodiment, the transaction processor 134 processes most transactions conducted through the system 130. As will be discussed below, the transaction processor 134 handles employer setup (FIGS. 4-5), vendor registration (FIG. 6), employee registration (FIGS. 7-8), employee updates (FIGS. 9-11), change in employee employment status (FIG. 12), employee purchases (FIGS. 13A-15), and payroll process (FIGS. 16-17). It should be noted, however, that the transaction processor 134 might be a plurality of special-purpose processors that individually handle the specific tasks of the transaction processor 134. Other divisions of the tasks conducted by the transaction processor 134 are also possible. In addition to processing data, the transaction processor 134 preferably includes a message interface 148 that is suitable for communicating with the employee 100, vendor 104, payroll system 116, and/or employer 110. Communications through the message interface 148 may be by email, posted to a message board accessible (with security) at the web site 132, and/or otherwise forwarded or accessible to their intended recipients. Messages through the message interface 148 may be stored and forwarded by the transaction processor 134 as appropriate.

The accounting system 136 and the verification system 138 may be implemented as separate subsystems (as shown) or as a single subsystem. The accounting system 136 preferably keeps track of all payments, for all employees 100, and to and from all vendors 104 and payroll systems 116. The accounting system 136 may be a standard accounting system, a modified accounting system, or a custom accounting system that keeps track of the payments. The accounting system may be able to generate invoices and/or messages and send them to appropriate payroll systems 116 for reminder or invoicing purposes. The verification system 138 preferably keeps track of and verifies that all funds have been received from the appropriate parties and have been sent to the appropriate parties. The verification system may interface with the accounting system 136, transaction processor 134, and/or database 140 to compare and verify that the appropriate funds have been received and sent. The accounting system 136 and the verification system 138 may be able to send and/or receive messages directly or they may interface with the message interface 148 and/or the user interface 146. Messages sent and received by these systems 136,138, may be stored and forwarded as appropriate.

The database 140 may be any storage device or a plurality of devices capable of storing data thereon. The system's 130 subsystems such as the web site 132, transaction processor 134, accounting system 136, verification system 138, and administration web site 142, preferably have appropriate access rights to the database 140 to send and receive data therefrom. Appropriate parties (e.g. vendors 104, employers 110, payroll systems 116, and/or the accounting system 136) may have appropriate access to the information stored on the database 140. The program and known security systems will limit access for each party to information appropriate to each party.

An administration web site 142 may be included in the present invention to allow system administration (FIG. 3) to access the internal processes of the web site 132, transaction processor 134, accounting system 136, and/or verification system 138. The system administrators may manually add information to the system 130 using the administration web site 142. The administration web site 142 may also be used for system administrators to provide maintenance to the system 130.

FIGS. 4-18 show exemplary processes that may be used to implement the present invention. The processes are meant to be exemplary and are not meant to limit the scope of the invention.

FIG. 4 shows a first preferred exemplary embodiment of an employer setup process of the present invention in which an outsourced payroll processor 116a is used. In this embodiment, the payroll processor 116a or a third party (e.g. the system administrator) informs the employer 110 about the availability of a new service. The employer 110 requests participation in the system 130 through the payroll processor 116a or the third party. Either the employer 110 submits an online registration (possibly through a web site user interface 146 or a transaction processor message interface 148) to the system 130 or the payroll processor 116a submits an online registration (possibly through a web site user interface 146 or a transaction processor message interface 148) on behalf of the employer 110 to the system 130. The party submitting the information would be required to provide information about the employer 110 such as its name, address, phone number, employer identification, bank routing numbers, current employees, and other relevant data. The transaction processor 134 registers the employer 110 in the database 140 and assigns the employer 110 a unique employer identification. Preferably, the transaction processor 134 sends confirmation to payroll processor 116a and/or the employer 110 that the employer 110 may now offer a new service to its employees 100. The employees 100 may then be notified (e.g. by email or at a company meeting) of the new benefit and supplied with the unique employer identification.

FIG. 5 shows a second preferred exemplary embodiment of an employer setup process of the present invention in which the employer 110 uses payroll software 116b. In this embodiment, the employer 110 requests participation in the system 130 by submitting an online registration (possibly through a web site user interface 146 or a transaction processor message interface 148) to the system 130. The employer 110 would be required to provide information such as its name, address, phone number, employer identification, bank routing numbers, current employees, and other relevant data. The transaction processor 134 registers the employer 110 in the database 140 and assigns the employer 110 a unique employer identification. As shown, the transaction processor 134 may send relevant information to the accounting system 136 so that the employer 110 can be added as a customer of the system 130. Preferably, the transaction processor 134 sends a confirmation to the employer 110 that the employer 110 may now offer a new service to its employees 100. The employees 100 may then be notified (e.g. by email or at a company meeting) of the new benefit and supplied with the unique employer identification.

FIG. 6 shows an exemplary embodiment of a vendor registration process of the present invention. As set forth above, the term “vendor 104” is used to describe such exemplary goods and service providers as the government, lenders, investment companies, services providers, and goods providers. A vendor 104 registers with the web site 132, using a password-protected user identification (e.g. Microsoft®.NET Passport ID) or other verifiable identification or number. The vendor 104 submits an online registration (possibly through a web site user interface 146 or a transaction processor message interface 148) to the system 130. The vendor 104 would be required to provide information such as its name, address, phone number, tax identification number, bank routing numbers, and other relevant data to allow electronic funds transfer. (The vendor 104 would not be required to supply the unique employee identifications, as that could be the responsibility of the employees 100.) The system 130 asks the vendor 104 to print registration/funds transfer details to present to the vendor's bank to verify accuracy. In one embodiment, the web site 132 sends the vendor's details to the transaction processor 134 that, in turn, provides the information to the database 140 where it is stored. The system 130 preferably generates a unique vendor identification that is supplied to the vendor 104 along with a confirmation of the vendor's details. It should be noted that the vendor 104 is responsible for accuracy of supplied details and is liable for any inaccuracies. The vendor 104 may provide the unique vendor identification to all the employees 100 who may want to set up an automatic payroll deduction to this vendor 104. Alternatively, the vendor's name may be added to a list stored at the web site 132 so that employees 100 desiring to purchase goods and/or services from the vendor 104 may select the vendor's name. If a vendor 104 is not registered with the system 130, the instructions for vendor registration can be obtained from the web site 132 by the vendor 104, the employee 100, or any visitor. Instructions can be printed and presented to potential vendors 104 as needed. It should be noted that certain vendors 104 may be registered directly by the system administration and might not have to register using the registration process described above.

Once the employer 110 has been registered, the employer's employees 100 may register to take advantage of the system. FIGS. 7 and 8 show two exemplary processes by which the employee 100 may register.

FIG. 7 shows a first preferred exemplary embodiment of an employee registration process of the present invention in which the employee 100 controls all information about the employee 100. This embodiment is particularly suitable if the employer 110 wants to reduce its workload. In one preferred embodiment, the employee 100 registers using the web site 132. The employee 100 may use a password-protected identification (e.g. Microsoft's®.NET Passport ID) or may set up an account using personal information verifiable by the system. The employee 100 would be asked to supply relevant information including the unique employer identification (or the name of the current employer), name, address, phone number, social security number, bank routing numbers, current salary or other determination of payroll limits, current payroll deduction status, and data required for a loan application. The web site 132 then sends the employee registration request to the transaction processor 134 that, in turn, may generate a unique employee identification. The transaction processor 134 preferably sends the employee registration request to the payroll system 116. The system 130 may also ask the employee 100 to print, sign, and send a registration document to the payroll system 116. The registration document preferably includes the unique employee identification and authorization for automatic payroll deductions through the system 130. Alternatively, the registration document may be sent electronically to the payroll system 116 using electronic verification, electronic signature, or digital signature as verification of identity. Other alternatives could include the employer 110 pre-registering its employees 100, manual verifications (e.g. a phone call to the payroll system 116), or no verification. The payroll system 116 verifies the information provided by the employee 100 and sends a registration confirmation to the system 130 (e.g. by email, fax, or by logging onto the web site 132) acknowledging that the employee 100 is employed by the employer 110 and verifying any relevant information. Once the employee's information has been confirmed, the transaction processor 134 updates the employee's status in the database 140 and notifies the employee 100 (e.g. by email) that registration has been confirmed. It should also be noted that the supplied information might be supplied to or available to user authorized appropriate parties (e.g. vendors 104, employers 110, payroll systems 116, and/or the accounting system 136).

FIG. 8 shows a second preferred exemplary embodiment of an employee registration process of the present invention in which the payroll system 116 controls at least some information about the employee 100. This method of employee registration is particularly suitable when the employer's 110 human resource department or the payroll system 116 controls certain information (e.g. name and address) about the employee 100. This embodiment may provide some additional assurance to vendors 104 (e.g. lenders, insurers, and original equipment manufacturers) that information in the system 130 is accurate. In this embodiment, the employee 100 registers using the web site 132. The employee 100 may use a password-protected identification (e.g. Microsoft's®.NET Passport ID) or may set up an account using personal information verifiable by the system. The employee 100 would be asked to supply only enough information for self-identification. The web site 132 then sends the employee registration request to the transaction processor 134 that, in turn, may generate a unique employee identification. The transaction processor 134 preferably sends the employee registration request to the payroll system 116. The system 130 may also ask the employee 100 to print, sign, and send a registration document to the payroll system 116. The registration document preferably includes the unique employee identification and authorization for automatic payroll deductions through the system 130. Alternatively, the registration document may be sent electronically to the payroll system 116 using electronic verification, electronic signature, or digital signature as verification of identity. Upon receipt of the registration request and/or registration document, the payroll system 116 updates its internal database to release information pertaining to the employee 100 to the system 130. The payroll system 116 then sends a registration confirmation to the system 130 (e.g. by email, fax, or by logging onto the web site 132) acknowledging that the employee 100 is employed by the employer 110 and providing any relevant information. Once the employee's information has been received, the transaction processor 134 updates the employee's status in the database 140 and notifies the employee 100 (e.g. by email) that registration has been confirmed. It should also be noted that the supplied information might be supplied to or available to user authorized appropriate parties (e.g. vendors 104, employers 110, payroll systems 116, and/or the accounting system 136).

FIGS. 9-12 show exemplary processes by which an employee 100 (or other party) may update information pertaining to the employee 100. Although not specifically described in this disclosure, similar update processes may be used to update information pertaining to vendors 104, employers 110, and/or payroll systems 116.

FIG. 9 shows a first preferred exemplary embodiment of an employee update process of the present invention in which the employee 100 controls all information about the employee 100. In this embodiment, the employee 100 logs onto the web site 132 and updates any information that has changed (including a change in employment). The updated information is then stored in the database 140. It should be noted that the update process might take place through the transaction processor 134. It should also be noted that the updated information might be supplied to or available to user authorized appropriate parties (e.g. vendors 104, employers 110, payroll systems 116, and/or the accounting system 136).

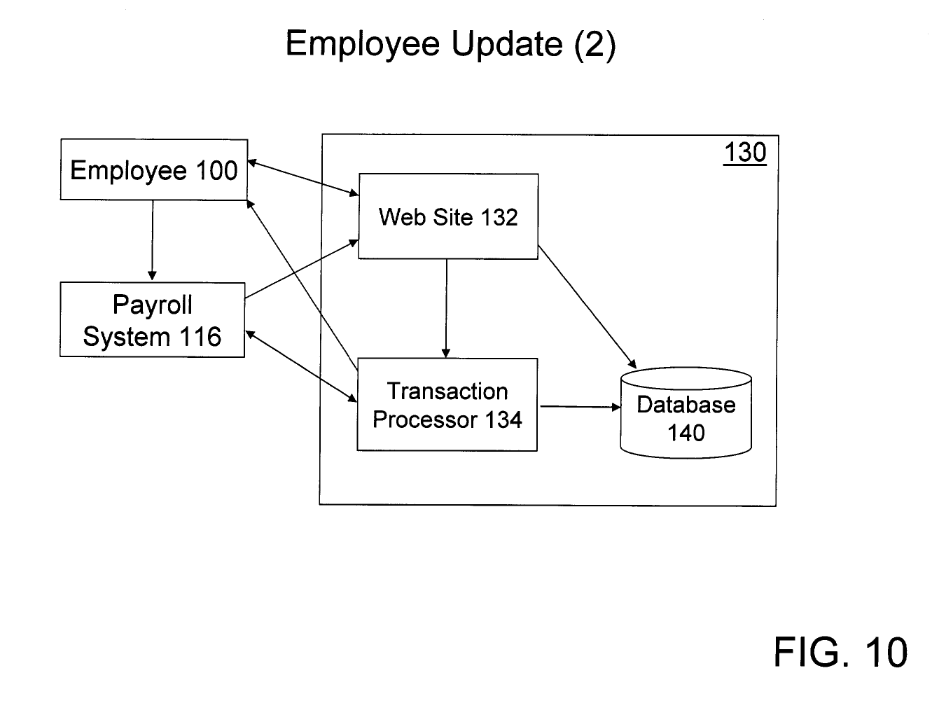

FIG. 10 shows a second preferred exemplary embodiment of an employee update process of the present invention in which the employee 100 controls all the information about the employee 100 and the employer 110 and/or the payroll system 116 requires notification of updates. In this embodiment, the employee 100 logs onto the web site 132 and updates any information that has changed (including a change in employment). In this embodiment, the web site 132 sends the employee update request to the transaction processor 134. The transaction processor 134 then sends the employee update request to the employer 110 and/or the payroll system 116. The system 130 may ask the employee 100 to print, sign, and send a new registration document to his employer 110 and/or the payroll system 116. The registration document preferably includes the unique employee identification and authorization for automatic payroll deductions through the system 130. Alternatively, the registration document may be sent electronically to the payroll system 116 using electronic verification, electronic signature, or digital signature as verification of identity. The employer 110 and/or the payroll system 116 may send an update confirmation to the system 130 or, alternatively, may log onto the web site 132 to confirm the update of the employee record. Preferably, the updated information is stored in the database 140. The transaction processor 134 may notify the employee 100 by email (or in an alternative suitable manner) that the update has been confirmed. It should also be noted that the updated information might be supplied to or available to additional user authorized appropriate parties (e.g. vendors 104, employers 110, payroll systems 116, and/or the accounting system 136).

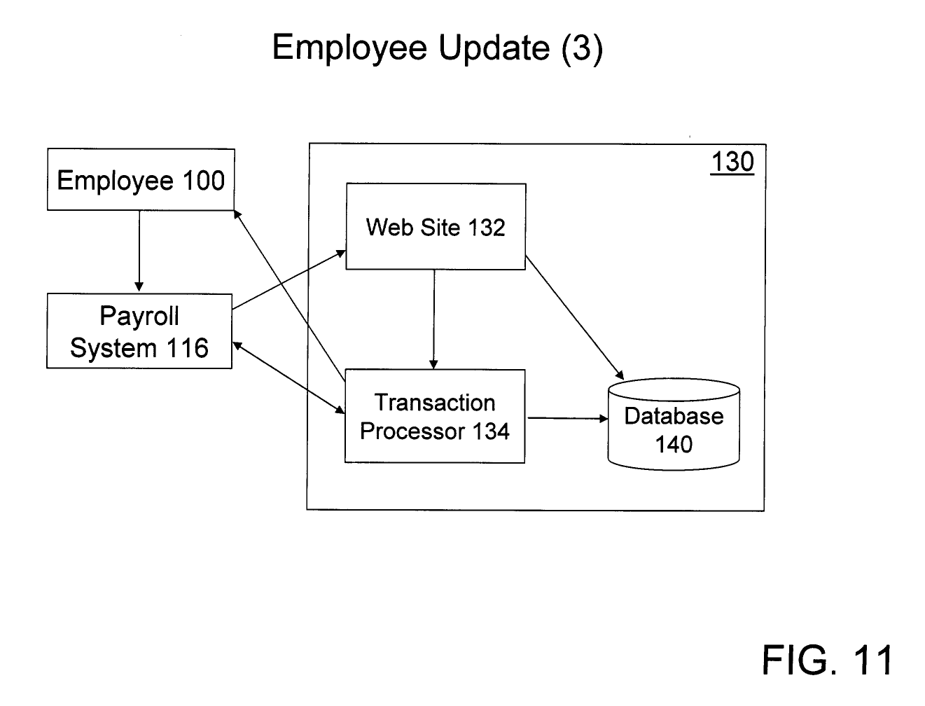

FIG. 11 shows a third preferred exemplary embodiment of an employee update process of the present invention in which the payroll system 116 controls at least some information about the employee 100. This embodiment may be useful to ensure accurate information is provided to vendors 104 (e.g. lenders, insurers, and OEMs). In this embodiment, the employee 100 notifies the payroll system 116 of a change in information (e.g. change of name, address, etc.). The payroll system 116 then sends the employee's updated information to the system 130. The payroll system 116 may send the updated information via email or, alternatively, by logging onto the web site 132. The transaction processor 134 then updates the database 140 with the employee's updated information. Preferably, the transaction processor 134 also notifies the employee 100 (e.g. by email or through the web site 132) that the update has been confirmed. It should also be noted that the updated information might be supplied to or available to user authorized appropriate parties (e.g. vendors 104, employers 110, payroll systems 116, and/or the accounting system 136).

FIG. 12 shows an exemplary embodiment of a change in employee employment status process of the present invention in which the payroll system 116 and/or employer 110 provides information about the employee's 100 change in employment status. (If the employee 100 updates his own employment status, the process would be done using the processes shown in FIGS. 9 and 10.) In this process, the payroll system 116 and/or employer 110 notifies the system 130 of change in employment status of the employee 100 using an email notification to the transaction processor 134 or by logging onto the web site 132 (through which the information flows to the transaction processor 134). The transaction processor 134 updates the employee status in the database 140. Preferably, the transaction processor 134 also forwards the change of employment confirmation to the payroll system 116 and/or employer 110. The transaction processor 134 notifies the employee 100 of the change in status and details any relevant insurance taken out through the system 130. (It should be noted that the “insurance” may be any credit-risk reducing feature.) If the employee 100 has a new employer 110 or has another source of income, the employee 100 would be prompted to provide the information to the system 130. The transaction processor 134 may also notify the lender-vendor 104a and/or insurer-vendor 104b of change in the employee's status. It should be noted that it is always the employee's responsibility to ensure that payments are made on time. When an insurable event occurs that interrupts normal automatic payroll deduction payment flow, it is the employee's responsibility to open a claim with the insurer-vendor 104b.

FIGS. 13A and 13B show an exemplary embodiment of an employee purchase process of the present invention in which the purchase is made through a registered goods-vendor 104c. (The goods-vendor 104c would be any vendor 104 providing a product for which only a single payment is desired. If the goods-vendor 104c will accept payments, the goods-vendor 104c may function as its own lender-vendor 104a and/or insurer-vendor 104b.) These figures also show interaction with an exemplary lender-vendor 104a and an exemplary optional insurance-vendor 104b. As discussed above, this process is described as a virtual flow and the true flow may be such that the employee 100 may be directed between vendor web sites 150 and/or the system web site 132 via the system web site 132 and/or transaction processor 134 or via alternate paths. It should also be noted that the steps that require the employee 100 to provide information or complete a loan/insurance application could be accomplished completely or partially by automatically or selectively using information stored in the database 140.

As shown in FIG. 13A, the employee 100 logs onto the web site 132, selects the registered goods-vendor 104c, and is redirected to the goods-vendor web site 150c. Alternatively, the employee 100 logs onto the goods-vendor web site 150c and selects a payment option indicating the purchase is to be paid for using the payment system of the present invention. The employee 100 selects goods such as a car, computer, one-time service (e.g. installation of a new furnace), or other product or service. The goods-vendor 104c may accept payment directly from the system 130 so as to function as a lender-vendor 104a. Alternatively, the employee 100 may be redirected from the goods-vendor web site 150c to a lender-vendor web site 150a where the employee 100 completes a loan application. During the regular process of completing the application, the employee 100 may be given the option to purchase insurance. The insurance would be to ensure that the lender-vendor 104a would be repaid for the loan even if the employee 100 loses his job. If the employee 100 selects this option, the lender-vendor web site 150a redirects the employee 100 to the insurer-vendor web site 150b where the employee 100 completes an insurance application (possibly being asked questions pertaining to employment and/or health). The insurer-vendor 104b may require the employee 100 to print, sign, and send appropriate insurance documentation to the insurer-vendor 104b. Alternatively, the insurance documentation may be sent electronically to the insurer-vendor 104b using electronic verification, electronic signature, and/or digital signature as verification of identity. It should be noted that the insurance documentation might be sent to the insurer-vendor 104b via the web site 132 and/or transaction processor 134. As discussed in the Consumer Financing reference, the system 130 may provide for insurance on behalf of the employee 100.

The employee 100 then returns to the lender-vendor web site 150a and completes the loan application. The lender-vendor 104a independently approves or declines the loan application. The lender-vendor 104a may partially base its decision to grant the loan on whether insurance is purchased. If the loan is approved, the lender-vendor 104a may require the employee 100 to print, sign, and send appropriate loan documentation to the lender-vendor 104a. Alternatively, the loan documentation may be sent electronically to the lender-vendor 104a using electronic verification, electronic signature, and/or digital signature as verification of identity. It should be noted that the loan documentation might be sent to the lender-vender 104a via the web site 132 and/or transaction processor 134.

The employee 100 then returns to the web site 132 for automatic payroll deduction authorization where the employee 100 verifies all information and completes the automatic payroll deduction authorization. The web site 132 then adds the automatic payroll deduction into the database 140 and sends the automatic payroll deduction request to the transaction processor 134. The transaction processor 134, in turn, sends the automatic payroll deduction request to the payroll system 116, the accounting system 136, and/or the verification system 138 to set up a recurring receivable.

It should be noted that the steps for obtaining a loan and/or insurance might be conducted prior to the selection of the goods and without connection to a specific goods-vendor 104c so as to obtain pre-approval for a loan. In this embodiment, once the employee 100 has pre-approval, he would contact the goods-vendor 104c to purchase the specific goods.

As shown in FIG. 13B, once the payroll system 116 confirms automatic payroll deduction setup, the employee 100 may begin or continue to make his purchase. The transaction processor 134 updates the order status in the database 140, notifies the employee 100 of the status of the automatic payroll deduction, and notifies the lender-vendor 104a that the automatic payroll deduction has been setup. If a purchase has already been made, the lender-vendor 104a may then send a purchase order to the system 130 (e.g. by email or by postal mail). If the lender-vendor 104a has not yet received the loan documentation, the lender-vendor 104a may wait until the loan documentation has been received. When the system 130 receives the purchase order, the transaction processor 134 updates the purchase order status in the database 140 and sends the purchase order into the accounting system 136. The transaction processor 134 may also forward the purchase order to the goods-vendor 104c who ships the goods to the employee 100 (or the employee 100 otherwise obtains the goods). In one preferred embodiment, the goods-vendor 104c sends a confirmation to the system 130 that the goods have been shipped/delivered and the transaction processor 134 updates the order status in the database 140, sends a confirmation to the accounting system 136 that the goods have been shipped/delivered, and notifies the lender-vendor 104a and/or the insurer-vendor 104b that the goods have been shipped/delivered. The accounting system 136 preferably issues an invoice to the lender-vendor 104a for payment of goods and the lender-vendor 104a pays the invoice to the system 130 and provides accounting details. The insurer-vendor 104b sends an invoice to the system 130 and the system 130 pays the invoice to the insurer-vendor 104b per terms and provides accounting details. The goods-vendor 104c sends an invoice to the system 130 and the system 130 pays the invoice to the goods-vendor 104c per terms and provides accounting details. It should be noted that, depending on the transaction, some of these steps might be eliminated, some of the steps might be conducted in a different order, and/or some of the steps might be conducted simultaneously.

FIG. 14 shows an exemplary embodiment of an employee purchase process of the present invention in which the purchase is for an ongoing service and is made through a registered service-vendor 104d using automatic payroll deduction. Unlike the example set forth in FIGS. 13A and 13B, there is no loan in this embodiment. For the purpose of this example, a service-vendor 104d may be any service provider to which ongoing periodic payments are made. For this example, exemplary service-vendors 104d may include landlords, insurance companies, utilities, savings plans, charities, memberships, and subscriptions. The employee 100 preferably sets up an automatic payroll deduction for service-vendor 104d by logging onto the web site 132 and selecting the service-vendor 104d. The web site 132 then redirects the employee 100 to the service-vendor web site 150d. In an alternative embodiment, the employee 100 logs onto the service-vendor web site 150c and selects a payment option indicating the service is to be paid for using the payment system of the present invention. The employee 100 may select his desired services on the service-vendor web site 150d. It should be noted that the employee 100 might provide all the information on the web site 132, with verification/setup to be made directly to the service-vendor 104d. If the service-vendor 104d requires it, the employee 100 may be instructed to print, sign, and send the service agreement to the service-vendor 104d. Alternatively, the service agreement may be sent electronically to the service-vendor 104d using electronic verification, electronic signature, or digital signature as verification of identity. The service-vendor web site 150d may return the employee 100 to the web site 132 for automatic payroll deduction authorization where the employee 100 verifies automatic payroll deduction authorization. The web site 132 adds the automatic payroll deduction into the database 140 directly or through the transaction processor 134. The automatic payroll deduction request is then sent to the transaction processor 134, which sends the automatic payroll deduction request to the payroll system 116, the accounting system 136, and the verification system 138 to set up a recurring receivable. The payroll system 116 preferably sends a confirmation that automatic payroll deduction has been setup or logs onto the web site 132 to confirm that the automatic payroll deduction has been setup. The transaction processor 134 may also notify the service-vendor 104d of the automatic payroll deduction setup and the employee 100 of the status of the automatic payroll deduction.

FIG. 15 shows an exemplary embodiment of a process by which an employee sets up and makes payments to a non-associated vendor 104. A non-associated vendor 104 may not receive all the benefits that the system has to offer. For example, the non-associated vendor 104 might not have a vendor web site that links to the system web site 132. Generally, a non-associated vendor 104 will be encouraged to register using the registration process set forth in FIG. 6. If the non-associated vendor 104 is unwilling or unable to register, the employee 100 or another third party may add the non-associated vendor 104 to the system 130 so that the non-associated vendor 104 may receive payments from the system 130. To add the non-associated vendor 104 to the system 130, the employee 100 logs onto the web site 132 and adds information he has obtained from the non-associated vendor 104 (e.g. all required routing/account numbers for the non-associated vendor 104 or its bank). The system would generate a unique identification for the non-associated vendor 104. Whoever registers the non-associated vendor 104 with the system 130 takes on the responsibility for the accuracy of the supplied information. To set up an automatic payroll deduction to a non-associated vendor 104 the employee 100 would log onto the web site 132 and complete an automatic payroll deduction request using his own information (e.g. his unique employee identification) and information about the non-associated vendor 104 including the non-associated vendor's unique identification. Preferably, the employee 100 then provides (either in printed form or as an electronic verification form) the complete or partially complete automatic payroll deduction request to the non-associated vendor 104 or its bank for verification and/or completion. Once the system 130 receives the automatic payroll deduction request (possibly through a web site user interface 146 or a transaction processor message interface 148), the web site 132 (and/or the transaction processor 134) adds/updates the information pertaining to the non-associated vendor 104 and the particular automatic payroll deduction in the database 140. If the transaction processor 134 has not received the information already, the web site 132 sends the automatic payroll deduction request to the transaction processor 134 and the transaction processor 134 provides (e.g. by email or by having the payroll system 116 to log onto the web site 132) the automatic payroll deduction request to the payroll system 116. Preferably, the payroll system 116 confirms that the automatic payroll deduction has been set up and the transaction processor 134 updates the automatic payroll deduction status in the database 140. Preferably, the transaction processor 134 sends a confirmation that the automatic payroll deduction has been set up to the employee 100 and to the non-associated vendor 104. The transaction processor 134 may also send the automatic payroll deduction request into the accounting system 136 and/or the verification system 138 to set up a recurring receivable.

FIG. 16 shows a first preferred exemplary embodiment of a payroll process of the present invention in which the system 130 of the present invention monitors all automatic payroll deduction transactions. In order to do this, the payroll system 116 must inform the system 130 when automatic payroll deductions are made. Payroll deductions may take place in two phases: first, the deduction is withheld from the employee's paycheck and second, the funds from the deduction are distributed to the appropriate vendors 104. These two phases may take place substantially simultaneously or there may be a delay that corresponds with the time between when the employee is supposed to be paid and when the vendors' 104 payment is due. By taking advantage of the delay, additional interest income can be earned by the party holding the funds. To implement the first phase of this process, the payroll system 116 notifies the system 130 that the automatic payroll deductions have been withheld by providing an automatic payroll deduction list. Preferably, the payroll system 116 also forwards the employee's net pay 102 to the employee 100. As shown in FIG. 17, an alternative to the payroll system 116 notifying the system 130 of deductions that have been withheld would be for the payroll system 116 to notify the system 130 of all automatic payroll deductions that have not been made. The transaction processor 134 (or the web site 132) forwards the automatic payroll deduction list to the verification system 138. The verification system 138 updates the database 140 for all automatic payroll deductions and retrieves information from the database 140 to determine discrepancies. For each discrepancy, the verification system 138 (or the accounting system 136) sends a summary to the transaction processor 134. The transaction processor 134 then notifies the employee 100, vendor 104, and/or lender-vendor 104a of non-payment of the automatic payroll deduction. The transaction processor 134 may also update the database 140 to reflect the discrepancies. To implement the second phase of this process, the verification system 138 (or the accounting system 136) sends an invoice summary for the current payroll to the accounting system 136 (shown as being sent via the transaction processor 134). The invoice summary describes all automatic payroll deductions actually withheld. The invoice summary may be provided on a regular periodic basis, may be provided to correspond with the employee's 104 receipt of his paycheck, or may be provided on the due date of the actual bills. In one preferred embodiment, the invoice summary includes the fee(s) paid by the employee 100 for the automatic payroll deduction service as well as the division of the fees between appropriate parties (e.g. the system 130, the payroll system 116, the lender-vendor 104a, and the insurer vendor 104b). Based on the invoice summary, the payroll system 116 distributes the funds to the lender-vendor 104a, other vendors 104, and/or fee recipients (e.g. a payroll processor 116a, the system 130). The funds may be distributed immediately when the employer 110 forwards the employee's gross pay 120, upon receipt of the invoice summary, or upon the appropriate due date(s). In the shown embodiment, a payment distributor 160 (such as a bank, the system 130, or the payroll system 116) may handle the distributions. The payroll system 116 and/or the payment distributor 160 preferably sends the system 130 an accounting summary of the distributions. The accounting system 136 may also invoice the payroll system 116 for a portion of the fee collected from the employee 100 for the automatic payroll distribution service.

FIG. 17 shows a second preferred exemplary embodiment of a payroll process of the present invention in which the system 130 of the present invention does not monitor all transactions. As discussed above, payroll deductions may take place in two phases: when the deduction is withheld and when the funds are distributed. In this embodiment, the first phase is implemented by the payroll system 116. The payroll system 116 also forwards the employee's net pay 102 to the employee 100 and, if applicable, notifies the system 130 of all automatic payroll deductions that have not been made. The transaction processor 134 (or the web site 132) notifies the employee 100, vendor 104, and/or lender-vendor 104a of non-payment of the automatic payroll deduction. The transaction processor 134 may also update the database 140 to reflect the nonpayment. The payroll system 116 also distributes the funds to the lender-vendor 104a, other vendors 104, and/or fee recipients. The funds may be distributed immediately when the employer 110 forwards the employee's gross pay 120, upon receipt of the invoice summary, or upon the appropriate due date(s). As shown in FIG. 16, a payment distributor 160 (such as a bank, the system 130, or the payroll system 116) may handle the distributions. The payroll system 116 and/or the payment distributor 160 preferably sends the system 130 an accounting summary of the distributions. The transaction processor 134 preferably forwards the accounting summary to the verification system 138, or the verification system 138 monitors the system to retrieve the accounting summary. Upon receipt of the accounting summary, the verification system 138 retrieves information from the database 140 to determine discrepancies between the database 140 and the accounting summary. For each discrepancy, the verification system 138 (or the accounting system 136) sends a summary to the transaction processor 134. The transaction processor 134, the verification system 138, or the accounting system 136 may also notify the employee 100, vendor 104, and/or lender-vendor 104a of non-payment of the automatic payroll deduction. The transaction processor 134 may also update the database 140 to reflect the nonpayment or discrepancies. The verification system 138 (or the accounting system 136) sends an invoice summary to the accounting system 136 (shown as being sent via the transaction processor 134). This summary describes all automatic payroll deductions actually withheld. The accounting system 136 may also invoice the payroll system 116 for a portion of the fee collected from the employee 100 for the automatic payroll distribution service.

FIG. 18 shows a simplified exemplary flow of funds using the system of the present invention. As shown, an employer 110a having one or more employees 100a, 100b transmits the gross pay 120a, 120b for each employee 100a, 100b, to a payroll system 116. The payroll system 116 (or the payment distributor 160) then distributes the funds to the appropriate recipients. It should be noted that the system 130 may provide the timing of the distributions and may monitor the distributions as set forth in FIGS. 16 and 17. For exemplary purposes, FIG. 18 shows several exemplary distributions. For example, the payroll system 116 may distribute the net pay 102a to the employee 100a and the net pay 102b to the employee 100b. The payroll system 116 may distribute a single loan payment 106a to the lender-vendor 104a that includes payments from both employee 100a and employee 100b. Assuming that only employee 100b chose to obtain insurance, the payroll system 116 may distribute a single insurance payment 106b to the insurer-vendor 104b that includes a payment from employee 100b. Assuming that only employee 100a chose to obtain goods from goods-vendor 104c, the payroll system 116 may distribute a single goods payment 106c to the goods-vendor 104c that includes a payment from employee 100a. The payroll system 116 may distribute a single service payment 106d to the service-vendor 104d that includes payments from both employee 100a and employee 100b. The payroll system 116 may distribute a single transaction fee payment 106e to the system 130 (system-vendor 104e) that includes payments from both employee 100a and employee 100b. The payroll system 116 may distribute a single tax payment 106e to the government (government-vendor 104f) that includes payments from both employee 100a and employee 100b. As implied in FIG. 18, additional employers 110b may be incorporated into the system and their respective employees' 100 payments 106 would be similarly distributed.

It should be noted that although the terms “web” and “web-dependent” are used throughout the specification, these terms may include any type of network or technology known (e.g. the internet, LAN, WAN, or any electronic communication media) or yet to be developed that allows similar types of communication. Similarly, although the invention appears to be set forth in terms of an employee 100 using a traditional computer, any type of network terminal known or yet to be developed could be used. For example, a kiosk located at an employer's place of business or a vendor's place of business could be used in place of a traditional computer. Similarly, if the vendor 104 is a credit card company or a bank and the employee 100 obtains pre-approval for a loan, the employee 100 could use a credit card-like (or debit card-like) card at any point of service (POS) or automated teller machine (ATM) such that the POS or ATM services at the network terminal.

It should be noted that an employee 100 may be employed by more than one employer 110. Similarly, more than one person (e.g. a married couple) could be referenced by the unique identification number.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A method for allowing an employee to self-administer automatic payroll deductions from his gross pay through a money management system, said method comprising the steps of:
(a) registering an employee in said money management system, said employee employed by an employer having a payroll system with automatic payroll deduction capabilities;
(b) receiving at least one transaction request from said employee to facilitate a financial obligation to at least one vendor;
(c) arranging for payment of said financial obligation through said payroll system with automatic payroll deduction capabilities;
(d) directing said payroll system to withdraw funds from said employee's gross pay using at least one automatic payroll deduction based on said financial obligation; and
(e) directing said payroll system to transfer said withdrawn funds to said at least one vendor.

2. The method of claim 1 wherein said step of registering an employee is in response to said employee submitting an employee registration request submitted by said employee.

3. The method of claim 1 further comprising the step of receiving an employee registration request via the web.

4. The method of claim 1 further comprising the step of said employee self-submitting an employee registration request through the web.

5. The method of claim 1 further comprising the step of providing access to a lender-vendor to arrange financing for said financial obligation.

6. The method of claim 5 further comprising the step of said lender-vendor determining creditworthiness of said employee based at least in part on the reliability factor provided by automatic payroll deductions.

7. The method of claim 1 further comprising the step of providing access to a credit-risk reducing feature.

8. The method of claim 1 further comprising the steps of:
(a) providing access to a lender-vendor to arrange financing for said financial obligation;
(b) providing access to a credit-risk reducing feature; and
(c) said lender-vendor determining creditworthiness of said employee based at least in part on the reliability factor provided by said credit-risk reducing feature.

9. The method of claim 1 wherein said step of directing said payroll system to transfer said withdrawn funds to said at least one vendor further comprises the step directing said payroll system to transfer said withdrawn funds to said at least one vendor via at least one electronic fund transfer.

10. The method of claim 1 further comprising the step of monitoring and verifying that said payroll system has withdrawn funds and transferred said withdrawn funds as directed.

11. A self-administered automatic payroll deduction system, said system comprising:
(a) at least one employee seeking to finance a financial obligation for the purchase of at least one good and/or service from at least one vendor using automatic payroll deductions withdrawn from gross pay;
(b) at least one employer employing said employee;
(c) at least one vendor providing said at least one good and/or service;
(d) at least one payroll system with automatic payroll deduction capabilities;
(e) a system website through which said at least one employee may submit employee registration request and at least one transaction request;
(f) said at least one transaction request identifying said at least one employee, said financial obligation, and said at least one vendor;
(g) means for processing said at least one transaction request;
(h) means for arranging for payment of said financial obligation through said at least one payroll system;
(i) means for directing said at least one payroll system to withdraw funds from said employee's gross pay using at least one automatic payroll deduction based on said financial obligation; and
(j) means for directing said at least one payroll system to transfer said withdrawn funds to said at least one vendor.

12. The system of claim 11 wherein said at least one good and/or service is selected from a group consisting of:
(a) loans;
(b) insurance;
(c) goods;
(d) services;
(e) investments;
(f) charitable contributions;
(g) taxes; and
(h) financial obligations.

13. The system of claim 11 wherein said at least one vendor is selected from a group consisting of:
(a) a lender;
(b) an insurance company;
(c) a goods provider;
(d) a service provider;
(e) an investment provider;
(f) a charity;
(g) the government; and
(h) and recipients of financial obligations.

14. The system of claim 11 further comprising a lender-vendor to arrange financing for said financial obligation.

15. The system of claim 14 further comprising said lender-vendor determining creditworthiness of said employee based at least in part on the reliability factor provided by automatic payroll deductions.

16. The system of claim 11 further comprising a credit-risk reducing feature.

17. The system of claim 11 wherein said at least one credit-risk reducer is credit insurance.

18. The system of claim 11 wherein said at least one credit-risk reducer is a recourse reserve fund.

19. The system of claim 11 further comprising:
(a) a lender-vendor to arrange financing for said financial obligation; and
(b) a credit-risk reducing feature;
(c) wherein said lender-vendor determining creditworthiness of said employee based at least in part on the reliability factor provided by said credit-risk reducing feature.

20. The system of claim 11 wherein said payroll system transfers said withdrawn funds to said at least one vendor via at least one electronic fund transfer.

21. The system of claim 11 further comprising means for monitoring and verifying that said payroll system has withdrawn funds and transferred said withdrawn funds as directed.
